(19) United States
(12) Patent Application Publication
(10) Pub. No.: US 2008/0220191 A1
(43) Pub. Date: Sep. 11, 2008

(54) Thermal Transfer Receiving Sheet

(75) Inventors: Masato Kawamura, Tokyo (JP); Chikara Tsukada, Tokyo (JP); Toshikazu Onishi, Tokyo (JP); Naoki Kubo, Tokyo (JP)

Correspondence Address: KRATZ, QUINTOS & HANSON, LLP, 1420 K Street, N.W., Suite 400, WASHINGTON, DC, 20005, US

(73) Assignee: OJI PAPER CO., LTD., Tokyo (JP)

(21) Appl. No.: 11/918,213

(22) PCT Filed: Apr. 10, 2006
(86) PCT No.: PCT/JP2006/307989

§ 371 Date: Oct. 11, 2007

(30) Foreign Application Priority Data
Apr. 11, 2005 (JP) 2005-113948
Feb. 14, 2006 (JP) 2006-037118

(51) Int. Cl. B41M 5/40

(52) U.S. Cl. 428/32.39

(57) ABSTRACT

There is provided a thermal transfer receiving sheet comprising a sheet-like support and an image receiving layer formed on at least one side of the sheet-like support, wherein the image receiving layer contains a polyester resin with a branched structure obtained by polycondensation of a polyhydric carboxylic acid component and a polyhydric alcohol component, and 30-75 mol % of the polyhydric carboxylic acid component is an aromatic dicarboxylic acid while 15-60 mol % is an alicyclic dicarboxylic acid.

### TECHNICAL FIELD

The present invention relates to a thermal transfer receiving sheet (hereinafter also referred to simply as “receiving sheet”) having an image receiving layer composed mainly of a dye-colorable resin (hereinafter also referred to simply as “receiving layer”). More specifically, the invention relates to a receiving sheet that, even with high-speed printing, has excellent releasability from the dye layers of ink sheets (hereinafter also referred to as “ink ribbons”) and excellent adhesion to the transferable laminate layers (hereinafter also referred to simply as “protective layers”) of ink ribbons, while also yielding high recording density and high image quality.

### BACKGROUND ART

Dye thermal transfer systems form images by laminating an ink ribbon and receiving sheet, transferring a sublimation dye in the ink ribbon dye layer section onto the receiving layer of the receiving sheet by heat supplied from a thermal head or the like, and then releasing the two. As dye-colorable resins for such receiving layers there have been proposed vinyl chloride-based resins, polyester-based resins, polyvinyl butyral-based resins, acrylic-based resins, cellulose-based resins and the like, and as release agents there have been proposed silicone-based release agents, fluorine-based release agents, fatty acid-based release agents and the like.

In recent years, in order to improve image storage life including light fastness and grease resistance, it has become common to use “overlaminate” systems that successively transfer a three- or four-color dye onto the ink ribbon and then form a protective layer. In such systems, the receiving layer must have the opposing properties of releasability from the ink ribbon dye layer surface and adhesion onto the ink ribbon protective layer surface.

Both releasability and adhesion can be achieved by using a vinyl chloride-based resin or cellulose-based resin as the dye-colorable resin in the receiving layer, but the use of vinyl chloride-based resins has been reduced in recent years because they tend to produce dioxin during waste combustion, while cellulose-based resins have low recording density and therefore cannot be applied for modern high printer speeds. The use of plasticizers has been proposed to increase the recording density of cellulose-based resins, but storage of printed images under high temperature and high humidity results in image exudation of images, while long-term storage leads to bleed out of the plasticizer, making it impossible to record normal images.

Polyester resins have been used in the prior art as dye-dyeable resins with high recording density (for example, see Japanese Unexamined Patent Publication (Kokai) No. 57-107885 (p. 1), Japanese Unexamined Patent Publication (Kokai) No. 2-34392 (p. 1), Japanese Unexamined Patent Publication (Kokai) No. 5-64978, (p. 2), Japanese Unexamined Patent Publication (Kokai) No. 5-238167, (p. 2) and Japanese Unexamined Patent Publication (Kokai) No. 2003-200668 (p. 2)), but when polyester resins with lower glass transition points are used to obtain high printing density, the heat resistance of the receiving layer is reduced and, depending on the printer design, the receiving layer may fuse with the ink ribbon. With the increasing printer speeds in recent years, it has become necessary for the ink ribbon and receiving layer to be released in a shorter time period after printing, and therefore receiving layers that exhibit sufficient heat resistance and yield high recording density at low energy have been desired.

Polyester resins have been problematic in that they cannot easily exhibit both releasability with receiving layers and adhesion with heat transferable protective layers. Polyester resins exhibit heat resistance when a curing agent such as an isocyanate is used, but they have insufficient molecular structural sites (functional groups) capable of chemically binding with the heat transferable protective layer, and when a large amount of curing agent is used for crosslinking of the functional groups of the polyester resin with the curing agent, it has not been possible to achieve adhesion with the heat transferable protective layer. On the other hand, when the amount of curing agent used is reduced to achieve adhesion with the heat transferable protective layer, the heat resistance is insufficient.

Polyester resins have traditionally been dye-dyeable resins with high printing density, but their drawbacks include low receiving layer heat resistance, only partial fusion with the receiving layer during high-energy printing, resulting in burning that lowers printing density, or poor adhesion with the protective layer and difficulty of protective layer transfer. The use of cellulose acetate butyrate (CAB) has been proposed to compensate for these drawbacks, but its poor compatibility that makes it difficult to form uniform coating solutions has led to problems such as notably reduced printing density.

It has also been shown that polyester resins with a branched structure yield clear images without release of the receiving layer from the base sheet, even when high heat energy is applied (for example, see Japanese Unexamined Patent Publication (Kokai) No. 2-112991, p. 1). In addition, there have been proposed polyester resins with specified glass transition temperatures and specified proportions between the alicyclic dicarboxylic acid component and alicyclic diol component (for example, see Japanese Unexamined Patent Publication (Kokai) No. 5-581 (p. 2) or Japanese Unexamined Patent Publication (Kokai) No. 7-290843 (p. 2)), and branched structure polyester resins are mentioned as examples. However, increased printer speeds introduce problems such as insufficient dye colorability and reduced printing density.

As a method for improving printing density there has been proposed the use of a polyester resin composed mainly of an aromatic compound (for example, see Japanese Unexamined Patent Publication (Kokai) No. 2-34392, p. 1), but the light fastness has been inadequate.

### DISCLOSURE OF THE INVENTION

It is an object of the invention to improve on the aforementioned drawbacks of the prior art by providing a receiving sheet with satisfactory transfer of the ink ribbon protective layer onto the receiving layer surface, as well as excellent releasability from the ink ribbon, high recording density and good light fastness, even during high-speed printing.

The scope of the invention encompasses the following aspects.

(1) A thermal transfer receiving sheet comprising a sheet-like support and an image receiving layer formed on at least one side of the sheet-like support, the thermal transfer receiving sheet being characterized in that the image receiving layer contains a polyester resin with a branched structure obtained by polycondensation of a polyhydric carboxylic acid component and a polyhydric alcohol component, and in that 30-75 mol % of the polyhydric carboxylic acid component is an aromatic dicarboxylic acid while 15-60 mol % thereof is an alicyclic dicarboxylic acid.

(2) The thermal transfer receiving sheet according to (1) above, wherein the polycondensation components of the polyester include 0.5-10 mol % of a trihydric or greater alcohol component and/or a trihydric or greater carboxylic acid component as the polyhydric alcohol component or polyhydric carboxylic acid component, respectively.

(3) The thermal transfer receiving sheet according to (1) or (2) above, wherein 10-80 mol % of the polyhydric alcohol component is an alicyclic glycol compound and/or aromatic glycol compound.

(4) The thermal transfer receiving sheet according to any one of (1) to (3) above, wherein the image receiving layer contains a reaction product comprising the polyester resin and an epoxy-modified silicone and/or epoxy polyether-modified silicone as components.

(5) The thermal transfer receiving sheet according to (4) above, wherein another component of the reaction product is an alcohol-modified silicone.

(6) The thermal transfer receiving sheet according to any one of (1) to (3) above, wherein the image receiving layer contains a reaction product comprising (a) the polyester resin, (b) an isocyanate compound and (c) an isocyanate group-reactive polyether-modified silicone and/or carbinol-modified silicone, and further includes a non-reactive polyether-modified silicone.

(7) The thermal transfer receiving sheet according to any one of (1) to (3), wherein the image receiving layer contains a bisphenol A-polycarbonate resin and/or bisphenol Z-polycarbonate resin.

(8) The thermal transfer receiving sheet according to any one of (1) to (3), wherein the image receiving layer contains a silanol group-containing polysiloxane at 1-40 parts by weight with respect to 100 parts by mass of the dye-dyeable resin.

(9) The thermal transfer receiving sheet according to (8) above, wherein the silanol group-containing polysiloxane is a silanol group-containing methylphenylpolysiloxane.

The receiving sheet of the invention is a receiving sheet with high printing density, satisfactory light fastness of images, and excellent ink ribbon protective layer transferability and releasability between the receiving layer and ink ribbon, even during high-speed printing.

### BEST MODE FOR CARRYING OUT THE INVENTION

### (Receiving Layer)

The invention relates to a receiving sheet prepared by forming a receiving layer on at least one side of a sheet-like support, wherein the receiving layer includes a polyester resin that has a branched structure in the molecule and is synthesized by polycondensation of a polyhydric carboxylic acid component and a polyhydric alcohol component that contain specified monomer components. The branched structure in the polyester molecule contains, for example, a trihydric or greater alcohol component and/or a trihydric or greater carboxylic acid component as the polycondensation components of the polyester.

### (Polyhydric Carboxylic Acid Component)

It is important that 30-75 mol % of the polyhydric carboxylic acid component used for the invention is an aromatic dicarboxylic acid, and 15-60 mol % is an alicyclic dicarboxylic acid. Preferably, 30-70 mol % of the polyhydric carboxylic acid component is an aromatic dicarboxylic acid component and 20-60 mol % is an alicyclic dicarboxylic acid component. If the aromatic dicarboxylic acid component constitutes less than 30 mol % it may not be possible to achieve sufficient dye colorability, and if it constitutes more than 75 mol % the light fastness of the obtained polyester resin will tend to be reduced. If the alicyclic dicarboxylic acid component constitutes less than 15 mol % the light fastness of the obtained polyester resin will tend to be reduced, and if it constitutes more than 60 mol % it may not be possible to achieve sufficient dye colorability.

As alicyclic dicarboxylic acids there may be mentioned those having at least one alicyclic ring in the molecule as the backbone of the molecular structure. Specifically, these include cyclopropane rings, cyclobutane rings, cyclopentane rings, cyclohexane rings, decalin rings, norbornane rings, adamantane rings and the like.

As specific examples of alicyclic dicarboxylic acids there may be mentioned 1,4-cyclohexanedicarboxylic acids such as 1,4-cyclohexanedicarboxylic acid, 2-methyl-1,4-cyclohexanedicarboxylic acid, 2-ethyl-1,4-cyclohexanedicarboxylic acid, 2-propyl-1,4-cyclohexanedicarboxylic acid, 2-butyl-1,4-cyclohexanedicarboxylic acid, 2-t-butyl-1,4-cyclohexanedicarboxylic acid, 2,3-dimethyl-1,4-cyclohexanedicarboxylic acid, 2,3-diethyl-1,4-cyclohexanedicarboxylic acid, 2,3-dipropyl-1,4-cyclohexanedicarboxylic acid, 2,3-dibutyl-1,4-cyclohexanedicarboxylic acid, 2-methyl-3-ethyl-1,4-cyclohexanedicarboxylic acid, 2-methyl-3-propyl-1,4-cyclohexanedicarboxylic acid, 2-methyl-3-butyl-1,4-cyclohexanedicarboxylic acid, 2-ethyl-3-propyl-1,4-cyclohexanedicarboxylic acid, 2-ethyl-3-butyl-1,4-cyclohexanedicarboxylic acid and 2-methyl-3-t-butyl-1,4-cyclohexanedicarboxylic acid, as well as their alkyl derivatives;
2,6-decalinedicarboxylic acids such as 2,6-decalinedicarboxylic acid, 3-methyl-2,6-decalinedicarboxylic acid, 3-ethyl-2,6-decalinedicarboxylic acid, 3-propyl-2,6-decalinedicarboxylic acid, 3-butyl-2,6-decalinedicarboxylic acid, 3,4-dimethyl-2,6-decalinedicarboxylic acid, 3,4-diethyl-2,6-decalinedicarboxylic acid, 3,4-dipropyl-2,6-decalinedicarboxylic acid, 3,4-dibutyl-2,6-decalinedicarboxylic acid, 3,8-dimethyl-2,6-decalinedicarboxylic acid, 3,8-diethyl-2,6-decalinedicarboxylic acid, 3,8-dipropyl-2,6-decalinedicarboxylic acid, 3,8-dibutyl-2,6-decalinedicarboxylic acid, 3-methyl-4-ethyl-2,6-decalinedicarboxylic acid, 3-methyl-4-propyl-2,6-decalinedicarboxylic acid, 3-methyl-4-butyl-2,6-decalinedicarboxylic acid and 3-ethyl-4-butyl-2,6-decalinedicarboxylic acid, as well as their alkyl derivatives; and
cyclopropanedicarboxylic acid, cyclobutanedicarboxylic acid, 1,2-cyclohexanedicarboxylic acid, 1,3-cyclohexanedicarboxylic acid, 3-methyl-1,2-cyclohexanedicarboxylic acid, 4-methyl-1,2-cyclohexanedicarboxylic acid, 1,2-cyclopentanedicarboxylic acid, 1,3-cyclopentanedicarboxylic acid, 2,3-norbornanedicarboxylic acid, adamantanedicarboxylic acid, dimethyladamantanedicarboxylic acid, tricyclodecanedicarboxylic acid, 4,4′-carboxymethylcyclohexane, 4,4′-carboxyethylcyclohexane and the like. Preferred among these are 1,4-cyclohexanedicarboxylic acid, 1,2-cyclohexanedicarboxylic acid and 2,6-decalinedicarboxylic acid.

As aromatic dicarboxylic acids there may be used those with one aromatic ring as the backbone of the molecular structure, those with 2-3 independent aromatic rings in the backbone in the form of biphenyl, diphenylmethane, dibenzyl, stilbene or the like, and those with another 5- or 6-membered carbon ring fused with an aromatic ring, such as indene or tetralin. The number of carbon atoms in the aromatic dicarboxylic acid will normally be in the range of 8-30, preferably 8-20 and more preferably 8-15.

As specific examples of aromatic dicarboxylic acids there may be mentioned terephthalic acid, isophthalic acid, phthalic acid, 5-t-butylisophthalic acid, p-xylylenedicarboxylic acid, 1,4-naphthalenedicarboxylic acid, 2,6-naphthalenedicarboxylic acid, 2,7-naphthalenedicarboxylic acid, 4,4′-diphenyldicarboxylic acid, 4,4′-diphenylmethanedicarboxylic acid, 4,4′-diphenylpropanedicarboxylic acid, 4,4′-diphenyl etherdicarboxylic acid and 4,4′-benzophenonedicarboxylic acid. Preferred among these are terephthalic acid, isophthalic acid and phthalic acid.

As derivatives of the aforementioned polyhydric carboxylic acids that may be used in the same manner there may be mentioned ester compounds, acid anhydrides and acid halides of the aforementioned dicarboxylic acids. Of these, ester compounds and acid anhydrides are preferred, with particularly preferred ester compounds being C1-6 lower alkyl ester compounds comprising methyl, ethyl, propyl, isopropyl, butyl, amyl and hexyl groups, and the like.

The polyhydric carboxylic acid component in the polyester resin of the invention may if necessary contain an aliphatic dicarboxylic acid in addition to the aforementioned alicyclic and aromatic dicarboxylic acid. As aliphatic dicarboxylic acids there may be mentioned straight-chain or branched aliphatic dicarboxylic acids and their derivatives such as ester compounds, acid halides and acid anhydrides. As aliphatic dicarboxylic acids there may be mentioned aliphatic saturated dicarboxylic acids such as malonic acid, methylmalonic acid, dimethylmalonic acid, succinic acid, glutaric acid, adipic acid, pimelic acid, suberic acid, azelaic acid, sebacic acid, isosebacic acid, brassylic acid, dodecanedicarboxylic acid and polyalkenylsuccinic acid, aliphatic unsaturated dicarboxylic acids such as maleic acid, fumaric acid, itaconic acid, citraconic acid and glutaconic acid, and dimer acids or hydrogenated dimer acids of polymerizing fatty acids. Preferably used among these are adipic acid, sebacic acid, succinic anhydride and maleic anhydride.

The polyester resin of the invention has a branched structure in the molecule, and it may be formed by, for example, adding a trihydric or greater carboxylic acid into the carboxylic acid component. As specific examples of trihydric or greater carboxylic acid components there may be mentioned trihydric or greater carboxylic acids such as trimellitic acid, tricarballylic acid, camphoronic acid, trimesic acid, 1,2,5-naphthalenetricarboxylic acid, 2,3,6-naphthalenetricarboxylic acid, 1,8,4-naphthalenetricarboxylic acid, pyromellitic acid, benzophenonetetracarboxylic acid and polymerizing fatty acid trimer acids, as well as their ester compounds and acid anhydrides. Preferred for use among these are trihydric carboxylic acids such as trimellitic acid.

The content of the trihydric or greater carboxylic acid is preferably 0.5-10 mol %, more preferably 1-8 mol % and even more preferably 3.5-7 mol % of the polyhydric carboxylic acid component. If the content of the trihydric or greater carboxylic acid component exceeds 10 mol %, excessive gelling may occur due to crosslinking of the obtained polyester resin, often impairing the solubility of the resin. At less than 0.5 mol %, on the other hand, the branched structure of the obtained polyester resin may be insufficient, thus reducing the glass transition temperature or resulting in insufficient heat resistance.

There may also be added to the polyhydric carboxylic acid component for the invention a monohydric carboxylic acid such as formic acid, acetic acid, butyric acid, 2-methylpropanoic acid, valeric acid, isooctylic acid, laurylic acid, myristic acid, palmitic acid, stearylic acid, isostearylic acid, arachic acid, linolic acid, oleic acid, elaidic acid, tall fatty acid or the like, and/or an ester compound thereof, within a range that does not interfere with the effect of the invention. The content of such compounds is preferably in the range of no greater than 10 mass %, more preferably no greater than 5 mass % and even more preferably no greater than 2 mass % with respect to the polyhydric carboxylic acid component.

### (Polyhydric Alcohol Component)

The polyhydric alcohol component used as the starting material for the polyester resin of the invention is not particularly restricted, and various publicly known ones may be used such as aromatic glycols (glycols are also referred to as “diols”), alicyclic glycols, aliphatic glycols and the like, which may be used alone or in combinations of two or more.

The polyester resin of the invention contains the alicyclic glycol and/or aromatic glycol at preferably 10-80 mol % and more preferably 15-75 mol % of the polyhydric alcohol component used as the starting material. If the content of the alicyclic glycol and/or aromatic glycol in the polyhydric alcohol component is less than 10 mol % the obtained polyester resin may have inferior dyeability, while if it exceeds 80 mol %, the glass transition temperature may increase and the dyeability may also be inferior. The content of alicyclic glycols in the polyhydric alcohol component is preferably 10-60 mol %, and the content of aromatic glycols in the polyhydric alcohol component is preferably 30-75 mol %.

As examples of aromatic glycols there may be mentioned bisphenol A, and ethylene oxide and/or propylene oxide addition products of bisphenol A. For example, an ethylene oxide addition product of bisphenol A has ethylene oxide ether-bonded to the hydroxyls of the bisphenol A, and preferably 1-5 moles of ethylene oxide are ether-bonded to 1 mole of bisphenol A. A specific example is 4,4′-bis(2-hydroxyethyl)bisphenol A. There may also be mentioned 4,4′-methylenediphenol and its ethylene oxide and/or propylene oxide addition product, p-xylenediol and its ethylene oxide and/or propylene oxide addition product, biphenol and its ethylene oxide and/or propylene oxide addition product, p-xylenediol and 2,5-naphthalenediol. Among these there are preferably used 4,4′-methylenediphenol ethylene oxide and/or propylene oxide addition product, bisphenol A ethylene oxide and/or propylene oxide addition product and biphenol ethylene oxide and/or propylene oxide addition product.

As alicyclic glycols there may be mentioned, specifically, 1,4-cyclohexanediol, 1,2-cyclohexanediol, 1,4-cyclohexanedimethanol, 1,4-cyclohexanediethanol, tricyclodecanedimethanol, hydrogenated bisphenol A (hydrogenated BIS-A), 1,2-cyclopentanediol, 1,4-cyclooctanediol, 2,5-norbornanediol, adamantanediol and the like. Preferred among these are 1,4-cyclohexanedimethanol, tricyclodecanedimethanol and hydrogenated BIS-A.

Aliphatic glycols may be mentioned as polyhydric alcohol components to be used with the aforementioned aromatic glycols and alicyclic glycols, and specifically there may be mentioned ethylene glycol, propylene glycol, 1,4-butanediol, 1,2-butanediol, 1,5-pentanediol, 1,6-hexanediol, neopentyl glycol, 2-n-butyl-2-ethyl-1,3-propanediol, diethylene glycol, triethylene glycol, polyethylene glycol and polytetramethylene glycol. Preferred among these are ethylene glycol and neopentyl glycol.

The polyester resin of the invention has a branched structure in the molecule, and the preferred method is condensation polymerization after adding a trihydric or greater alcohol component in addition to the aforementioned glycol component. As specific examples of trihydric or greater alcohol compounds there may be mentioned glycerol compounds such as glycerin, diglycerol and polyglycerol, and methylol compounds such as trimethylolethane, trimethylolpropane, trimethylolbutane, pentaerythritol, ditrimethylolpropane and dipentaerythritol. Trihydric alcohols such as trimethylolpropane are preferred for use.

The content of the trihydric or greater alcohol component is preferably 0.5-10 mol %, more preferably 1-8 mol % and even more preferably 3.5-7 mol % with respect to the total polyhydric alcohol component. If the content of the trihydric or greater polyhydric alcohol component in the polyhydric alcohol component exceeds 10 mol %, excessive gelling may occur due to crosslinking of the obtained polyester resin, often impairing the solubility of the resin. At less than 0.5 mol %, on the other hand, the branched structure of the obtained polyester resin may be insufficient, thus resulting in insufficient heat resistance.

There are no particular restrictions on the molecular weight of the polyester resin of the invention which is synthesized from the aforementioned starting materials, but it is preferably in the range of 3,000-30,000 and more preferably 5,000-20,000 as the number-average molecular weight in terms of polystyrene, measured by gel permeation chromatography (GPC). A number-average molecular weight of less than 3,000 may lead to fusion of the receiving layer and ink ribbon, while a number-average molecular weight of greater than 30,000 will increase the viscosity of the polyester resin-containing coating solution, possibly resulting in poor smoothness of the coated surface.

The glass transition temperature (Tg) of the polyester resin used for the invention is not particularly restricted, but is preferably 30-90° C. and more preferably 40-80° C. A polyester resin Tg of below 30° C. may result in fusion between the receiving layer and ink ribbon, while a Tg of above 90° C. may result in inferior dyeability of the receiving layer and insufficient printing density.

It is preferred to add an epoxy-modified silicone oil and/or epoxy polyether-modified silicone oil to the receiving layer of the invention. Addition of an epoxy-modified silicone oil or epoxy polyether-modified silicone oil can improve releasability between the ink ribbon and receiving layer and, during transfer of the protective layer, will allow the epoxy groups to bond to the acrylic resin or butyral resin serving as the protective layer component, resulting in satisfactory transferability of the protective layer. The content of the silicone oil is not particularly restricted but is preferably in the range of 0.5-20 parts by mass with respect to 100 parts by mass of the polyester resin. If the proportion of silicone oil is less than 0.5 part by mass with respect to 100 parts by mass of the polyester resin, adhesion between the receiving layer and protective layer will be notably reduced, and if it exceeds 20 parts by mass, releasability between the receiving layer and ink ribbon may be reduced.

An alcohol-modified silicone oil is also preferably used in the receiving layer of the invention, in addition to the aforementioned epoxy-modified silicone oil and/or epoxy polyether-modified silicone oil, to obtain satisfactory protective layer transferability with improved releasability. The content of the alcohol-modified silicone oil is not particularly restricted but is preferably in the range of 0.5-20 parts by mass with respect to 100 parts by mass of the polyester resin. If the proportion of alcohol-modified silicone oil is less than 0.5 part by mass with respect to 100 parts by mass of the polyester resin, releasability between the receiving layer and ink ribbon will be notably reduced, and if it exceeds 20 parts by mass, adhesion between the receiving layer and protective layer may be reduced.

The receiving layer of the invention contains a reaction product comprising (a) a polyester resin, (b) an isocyanate compound and (c) an isocyanate group-reactive (hereinafter referred to simply as “reactive”) polyether-modified silicone and/or carbinol-modified silicone, and it preferably further includes a non-reactive polyether-modified silicone.

By adding both a silicone oil that is reactive with isocyanate groups and a silicone oil that is non-reactive, it is possible to improve releasability between the ink ribbon and receiving layer and produce satisfactory protective layer transferability during transfer of the protective layer, and this is believed to result from interaction between the polyether groups and the acrylic resin or butyral resin serving as the protective layer component.

The content of the silicone oil is not particularly restricted, but preferably the total content of reactivity polyether-modified silicone oil and carbinol-modified silicone oil is in the range of 0.2-20 parts by mass and even more preferably 0.3-10 parts by mass with respect to 100 parts by mass of the polyester resin. If the total content of reactivity polyether-modified silicone oil and carbinol-modified silicone oil is less than 0.2 part by mass, releasability between the receiving layer and ink ribbon may be insufficient, and if it exceeds 20 parts by mass, adhesion between the receiving layer and protective layer may be reduced.

The content of non-reactive polyether-modified silicone oil is preferably in the range of 0.1-10 parts by mass and even more preferably 0.2-8 parts by mass with respect to 100 parts by mass of the polyester resin. If the non-reactive polyether-modified silicone oil content is less than 0.1 part by mass, adhesion between the receiving layer and protective layer will be insufficient, and if it exceeds 10 parts by mass, exudation may occur with formed images that have been stored for long periods.

Also, the content of non-reactive polyether-modified silicone oil is preferably in the range of 1-40 parts by mass and even more preferably 2-30 parts by mass with respect to 100 parts by mass of the total content of the reactive polyether-modified silicone oil and carbinol-modified silicone oil.

The reactive polyether-modified silicone oil has an active hydrogen group in the molecule and a structure with a polyether such as polyethylene oxide or polypropylene oxide introduced at one end, both ends or a side chain of, for example, dimethylpolysiloxane as one type of silicone oil, while the C—OH group at the end of the polyether can be used as a reactive group. Compounds having epoxy or amino group groups, for example, introduced therein may also be used. Such reactive polyether-modified silicone oils can be produced by known processes, and as commercial products there may be mentioned BY16-004, SF8428, SH3771 (Toray/Dow Corning Silicone), X22-4272, X22-4952 (Shin-Etsu Chemical Co., Ltd.), and the like.

The carbinol-modified silicone oil has an —ROH group (where R is an alkyl group) introduced at both ends, one end or a side chain of dimethylpolysiloxane as a type of silicone oil, and the hydroxyl group may be used as a reactive group. Such carbinol-modified silicone oils can be produced by known processes, and as commercially products there may be mentioned BY16-848, BY16-201 (Toray/Dow Corning Silicone), KF6001, KF6002, KF6003, X22-4015 (Shin-Etsu Chemical Co., Ltd.) and the like.

The non-reactive polyether-modified silicone oil has some of the methyl groups at both ends, one end or side chains of dimethylpolysiloxane, as a type of silicone oil, replaced with —R(C₂H₄O)ₐ(C₃H₆O)_{b}R′. (Here, R and R′ represent C1 or greater alkyl, a and b are integers of 0 or greater, and a+b>1.)

Such non-reactive polyether-modified silicone oils can be produced by known processes, and as commercial products there may be mentioned SF8400, SF8410, SH3748, SH3749 (Toray/Dow Corning Silicone), KF351, KF352, KF353, KF6011, KF6015 (Shin-Etsu Chemical Co., Ltd.) and the like.

Known release substances may also be used therewith in amounts that do not impede performance according to the invention. These are not particularly restricted, and specifically there may be mentioned modified silicone oils such as dimethylsilicone oil, amino-modified silicone oil, carboxyl-modified silicone oil and methacrylic acid-modified silicone oil, hydrocarbon-based release substances such as paraffin wax, polyethylene and fluorocarbon, fatty acid-based release substances such as stearic acid and aliphatic amide-based, ester-based, alcohol-based, metal soap-based and natural wax-based release substances. Such release substances are preferably added in the range of 0.1-20 parts by mass with respect to 100 parts by mass of the dye-colorable resin in the receiving layer, although this is not restrictive.

For improved releasability, the dye-dyeable resin may be crosslinked using a crosslinking agent such as a polyvalent isocyanate compound, epoxy or organometallic compound. These crosslinking agents are preferably added to about 0.1-1,000 crosslinking agent functional groups for each functional group of the dye-dyeable resin.

A suitable known dye-dyeable resin may also be used with the receiving layer of the invention, in addition to the specific polyester resin with a branched structure in the molecule. Also, one or more resins such as polyester resins without a branched structure in the molecule, cellulose butyrate acetate, polyvinyl formal, polyacetal, polyacetal-based resins such as polyvinyl butyral, or bisphenol A (BIS-A) type epoxy resin, hydrogenated BIS-A type epoxy resin, polyvinyl chloride, polyvinylidene chloride, polyvinyl acetate, polystyrene, styrene-acrylonitrile copolymer, polyethylene, polypropylene, ethylene-vinyl acetate copolymer, polymethyl methacrylate, methyl methacrylate-styrene copolymer, polyamide, ethylcellulose, cellulose acetate, propylcellulose, cellulose nitrate, polycarbonate resin, phenoxy resin, polyurethane and the like may also be used, without any particular restrictions.

The receiving layer of the invention preferably contains a polycarbonate resin such as a bisphenol A-polycarbonate resin or bisphenol Z-polycarbonate resin for the purpose of improving releasability between the ink ribbon and receiving layer during printing. Specifically, the polycarbonate resin has high heat resistance and is effective for preventing fusion between the receiving layer and ink ribbon. The polycarbonate resin of the invention preferably contains bisphenol A or bisphenol Z as the basic unit, but it may be further modified using a linear aliphatic diol or alicyclic diol component during synthesis. The content of the polycarbonate resin is not particularly restricted but is preferably 5-100 parts by mass and more preferably 10-50 parts by mass with respect to 100 parts by mass of the polyester resin in the receiving layer. A content of less than 5 parts by mass may result in insufficient improvement in releasability between the ribbon and receiving layer, while a content of greater than 100 parts by mass may result in insufficient dye dyeability.

A silanol group-containing polysiloxane is preferably used in the receiving layer of the invention, since it will exhibit an excellent effect as a material having both the effect of improving adhesion with the heat transferable protective layer and suitably softening the cured dye-dyeable resin.

The silanol group-containing polysiloxane is not particularly restricted so long as it has a polysiloxane backbone and contains a silanol group at the end or a side chain. A silicone oil is also satisfactory if it contains a silanol group. Silanol group-containing polysiloxanes are generally classified as silicone resins or crosslinked silicones known as silicone varnishes, and the backbone is a polysiloxane main chain with methyl groups or phenyl or propyl groups on side chains. Specifically, they are compounds with structures such as dimethylpolysiloxane or methylphenylpolysiloxane, and have silanol groups replacing hydroxyl groups at the ends or some of the side chains. Preferred among these are silanol group-containing methylphenylpolysiloxanes, which have an increased effect of improving adhesion with the heat transferable protective layer.

According to the invention, the silanol groups exhibit a particular effect toward improving adhesion with the heat transferable protective layer, and therefore the silanol groups are essential. That is, the hydroxyl groups must be present, because the desired effect is reduced if the silanol-type hydroxyl groups are replaced with methoxy groups, methyl groups or the like. The content of silanol-type hydroxyl groups is preferably 0.1-15 mass % and more preferably 1-10 mass % based on the total mass of the polysiloxane. If the content of silanol-type hydroxyl groups is less than 0.1 mass % the adhesion with the heat transferable protective layer may be insufficient, and if it is greater than 15 mass %, the effect will be saturated and the stability of the polysiloxane will be compromised, potentially leading to unstable preparation of the coating solution for the receiving layer.

In order to improve adhesion with the heat transferable protective layer, the silanol group-containing polysiloxane in the receiving layer composed mainly of the dye-dyeable resin must be present at 1-40 parts by mass and preferably 2-30 parts by mass with respect to 100 parts by mass of the dye-dyeable resin. At less than 1 part by mass, sufficient adhesion with the heat transferable protective layer will not be achieved, while an amount of greater than 40 parts by mass is not economical because the effect will be saturated, and the absolute amount of dye-dyeable resin will be lower, tending to reduce the printing density.

For the purpose of controlling the dyeability, plasticizers may also be used alone or in combinations. Any publicly known plasticizers may be used, including phthalic acid ester-based, aliphatic dibasic acid ester-based, trimellitic acid ester-based, phosphoric acid ester-based, epoxy-based or polyester-based plasticizers. The plasticizer content is preferably about 1-50 parts by mass with respect to 100 parts by mass of the dye-dyeable resin in the receiving layer, while it is more preferably 1-30 parts by mass from the viewpoint of balance with bleed out.

For improved light fastness, there may be used an ultraviolet absorber (hereinafter referred to as UVA), hindered amine-based light stabilizer (hereinafter referred to as HALS) or antioxidant, either alone or in combinations. Commonly known UVAs include benzotriazole-based UVAs, triazine-based UVAs, oxalic anilide-based UVAs and benzophenone-based UVAs, but benzotriazole-based UVAs have a particularly wide absorption wavelength range compared to other UVAs and a large absorption peak at the high wavelength end, as well as high absorbance, and therefore a particularly excellent effect is obtained when they are used together with HALS. The content is about 1-70 parts by mass with respect to 100 parts by mass of the dye-dyeable resin in the receiving layer, while it is preferably 1-40 parts by mass from the viewpoint of balance between the UVA amount and the effect. HALS is a compound having a 2,2,6,6-tetramethylpiperidine backbone, and it is not particularly restricted so long as it has this backbone. HALS is added at 1-70 parts by mass with respect to 100 parts by mass of the thermoplastic resin in the receiving layer, and the content is preferably 1-40 parts by mass from the viewpoint of balance between the HALS amount and the effect.

The solid coating coverage of the receiving layer is adjusted to be in the range of preferably about 1-12 g/m² and more preferably 2-10 g/m². Incidentally, a receiving layer solid coating coverage of less than 1 g/m² will not allow the receiving layer to completely cover the support surface, which may lead to reduced image quality, and trouble caused by fusing as the receiving layer and ink ribbon bond under the head of the thermal head. On the other hand, a receiving layer solid coating coverage of greater than 12 g/m² is not only uneconomical since the effect will be saturated, but the receiving layer strength may be insufficient, the thickness of the receiving layer may increase, making it impossible for the insulating effect of the support to be adequately exhibited, and the image density may be reduced.

### (Sheet-Like Support)

As the support of the receiving sheet according to the invention there may be used paper composed mainly of cellulose pulp, or a synthetic resin film. For example, there may be suitably used paper including woodfree paper (acid paper, neutralized paper), mechanical paper, coated paper, art paper, glassine paper, resin-laminated paper and the like, films or sheets composed mainly of synthetic resins including polyolefins such as polyethylene or polypropylene, polyesters such as polyethylene terephthalate, polyamide, polyvinyl chloride, polystyrene, polycarbonate, polyvinyl alcohol and the like, or a porous monolayer stretched film or porous multilayer stretched film composed mainly of a thermoplastic resin such as a polyolefin or polyester (for example, synthetic paper, porous polyester film, etc.), as well as laminates prepared by laminating and bonding such films together, or such films with other films and/or paper.

The base surface layer for the support (base material on the receiving layer side) is not particularly restricted, but from the viewpoint of uniformity and tone of printed images, it is preferably a porous monolayer stretched film or porous multilayer stretched film (for example, synthetic paper, porous polyester film or the like) composed mainly of a thermoplastic resin such as a polyolefin or polyester.

In order to prevent static electricity and improve whiteness, a coating layer comprising any of various types of known conductive agents, white pigments, fluorescent dyes or the like may be formed between the sheet-like support and receiving layer.

According to the invention, paper composed mainly of cellulose pulp is most advantageous from a cost perspective among the aforementioned sheet-like supports, and is preferred because the obtained receiving sheet will have a hand quality similar to printing paper. When a paper support is used, it is preferred to form an interlayer comprising hollow particles on the support. There are no particular restrictions on the material and production process for the hollow particles used in the interlayer, and specifically the material forming the walls of the hollow particles may be a homopolymer of acrylonitrile, vinylidene chloride, styrene, acrylic acid ester or the like, or a copolymer thereof, or a mixture of their homopolymers. For example, the process for producing the hollow particles may involve introducing butane gas into resin particles and expanding them by heat, or it may employ an emulsion polymerization system.

### (Barrier Layer)

A barrier layer is preferably formed between the interlayer and receiving layer. The solvent used in the coating solution for the receiving layer will generally be an organic solvent such as toluene or methyl ethyl ketone, and therefore the barrier layer is effective as a barrier against deformation and deterioration of the hollow particles of the interlayer due to swelling and dissolution of the hollow particles caused by penetration of the organic solvent.

The resin used in the barrier layer is one that has excellent film formability, is resistant to penetration of organic solvents and exhibits elasticity and flexibility. Specifically, starches, modified starches, hydroxyethylcellulose, methylcellulose, carboxymethylcellulose, gelatin, casein, gum arabic, totally saponified polyvinyl alcohols, partially saponified polyvinyl alcohols, carboxy-modified polyvinyl alcohols, acetoacetyl group-modified polyvinyl alcohols, isobutylene-maleic anhydride copolymer salts, styrene-maleic anhydride copolymer salts, styrene-acrylic acid copolymer salts, ethylene-acrylic acid copolymer salts and the like, as well as water-soluble resins such as urea resins, urethane resins, melamine resins, amide resins and the like, may be used. There may also be used water-dispersible resins such as styrene-butadiene-based copolymer latexes, acrylic acid ester resin-based latexes, methacrylic acid ester-based copolymer resin latexes, ethylene-vinyl acetate copolymer latexes, polyester-polyurethane ionomers, polyether-polyurethane ionomers and the like. Water-soluble resins are preferred among the resins mentioned above. These resins may be used alone or in combinations of two or more.

The barrier layer may contain various pigments, and preferably expansive inorganic laminar compounds are used, as an excellent effect can be achieved not only for preventing penetration of the coating solvent but also preventing seepage of thermal transfer-dyed images. As examples of expansive inorganic laminar compounds there are more preferably used synthetic micas such as fluorine bearing mica, potassium tetrasilicic mica, sodium tetrasilicic mica, sodium teniolite, lithium teniolite and the like, or synthetic smectites such as sodium hectorite, lithium hectorite, saponite and the like. Particularly preferred among these is sodium tetrasilicic mica, as the desired particle size, aspect ratio and crystallinity can be achieved by melt synthesis methods.

### (Back Surface Layer)

A back surface layer may also be formed on the receiving sheet of the invention, on the side opposite the receiving layer (back side), for the purpose of improving traveling of the sheet, preventing static electricity, preventing damage to the receiving layer due to chafing of the receiving sheet, and preventing migration of the dye into the receiving sheet back surface from the receiving layer in adjacent contact therewith, when printed receiving sheets have been stacked together. A bonding resin and various conductive agents for antistatic treatment may also be added to the back surface layer. Such conductive agents are preferably cationic polymers. For most cases, the cationic polymer used may be polyethyleneimine, or a cationic monomer-containing acrylic-based polymer, a cation-modified acrylamide-based copolymer, a cationic starch or the like.

According to the invention, the coated layers including the interlayer, barrier layer, receiving layer and back surface layer are formed according to ordinary methods, preparing coating solutions containing the desired components for each, and using a publicly known coater such as a bar coater, gravure coater, comma coater, blade coater, air knife coater, gate roll coater, die coater, curtain coater, lip coater, slide bead coater or the like for coating onto the prescribed side of the sheet-like support, followed by drying and heat curing if necessary.

The receiving sheet may further be subjected to smoothing treatment to reduce irregularities in the receiving layer surface and achieve high smoothness. The smoothing apparatus used may be a calender apparatus ordinarily used in the papermaking industry, such as a supercalender, soft calender, gloss calender, clearance calender or the like.

It was found that when producing a receiving sheet having a structure with a hollow particle-containing interlayer and a receiving layer formed in that order on at least one side of the sheet-like support, the smoothness of the receiving layer surface can be effectively improved by performing smoothing treatment with a calender that accomplishes nipping between a metal heating roll and an elastic roll, after forming the interlayer and/or after forming the receiving layer, while even greater smoothness can be achieved by adjusting the surface temperature of the surface layer (interlayer or receiving layer) to within a range of 30-130° C. just prior to nipping. The surface temperature of the surface layer is more preferably in the range of 35-120° C. and even more preferably in the range of 40-115° C.

If the surface temperature of the surface layer is below 30° C. just prior to nipping, almost no effect will be exhibited on the smoothing treatment, whereas if it is above 130° C., heavier delamination will occur when the receiving layer is released from the metal heating roll, producing a poor outer appearance due to delamination lines.

According to the invention, the nipping is carried out after forming the interlayer or after forming the receiving layer, and if necessary it may be carried out both after forming the interlayer and after forming the receiving layer, although it is preferably carried out after forming the receiving layer.

When it is carried out after forming the receiving layer, for example, it appears that the calender causes plasticization of the interlayer and receiving layer resin due to the heat of nipping, deformation of the receiving sheet surface, transfer of the shape of the metal heating roll surface due to pressure, and smoothing of the receiving sheet surface by shear force of the receiving layer surface generated when it is released from the nip pressure, but if the receiving layer surface temperature is adjusted to 30-130° C. just prior to nipping, plasticization of the resin during nipping is evenly promoted in a shorter time period, thus accomplishing smoothing in a more efficient manner.

In order to adjust the surface temperature to the range of 30-130° C. just prior to nipping, the paper path in the smoothing treatment apparatus may be controlled so that the surface layer contacts and passes over the metal heating roll surface before passing through the nip section. For example, the surface temperature of the surface layer may be adjusted to 30-130° C. just prior to nipping by appropriately adjusting the contact area and heating time. From the standpoint of workability for the smoothing treatment, the heat treatment time is preferably in the range of 50-2000 msec. The surface temperature of the surface layer just prior to nipping can be measured using, for example, a non-contact radiation thermometer (IT-550F, trade name of Horiba, Ltd.).

An ordinary heating apparatus (or preheating apparatus) may also be used. Specifically, appropriate means such as a heating roll (or preheating roll), infrared heater or hot air generating device (such as an oven) may be used; methods using preheating rolls are convenient and efficient and are therefore preferred. The temperature conditions for the preheating roll, for example, are preferably 30-135° C., more preferably 35-125° C. and even more preferably 40-120° C.

The preferred nip pressure conditions for nipping are 0.2-150 MPa, more preferably 0.3-100 MPa and most preferably 2-50 MPa. The nipping time will depend on the hardness of the elastic roll and the nip pressure, but a time in the range of 5-500 msec is preferred. The temperature conditions for a metal heating roll are preferably 30-130° C., more preferably 35-120° C. and even more preferably 40-115° C., as a temperature range from room temperature to no higher than the melting point of the adhesive resin in the coating layer for the smoothing treatment.

The surface roughness of the metal heating roll is in the range of preferably 0.01-1.0 μm and even more preferably 0.02-1.0 μm, as the Ra value based on JIS B 0601. An Ra value of less than 0.01 μm may result in excessively high glossiness of the obtained product, leading to irregular gloss. On the other hand, an Ra of greater than 1.0 μm will increase the printing smoothness (Rp value) of the receiving layer surface on the obtained product, possibly leading to poor image uniformity.

According to the invention, the 20° glossiness (glossiness with an incident beam angle of 20°) of the receiving layer surface as measured according to JIS Z 8741 is preferably no greater than 80% and more preferably 30-70%. A satisfactory cushion property will be obtained by forming a hollow particle-containing interlayer, but a glossiness exceeding 80% may accentuate nicks in the receiving layer surface. When two receiving sheets are stacked together for storage, for example, the back side of the receiving sheet will contact the receiving layer surface, often creating fine nicks in the portions of the receiving layer surface and leading to irregular gloss, thus reducing the product value in terms of outer appearance. A receiving layer surface glossiness of less than 30% may lead to inferior image gloss when images are printed using a thermal transfer printer.

According to the invention, the smoothing treatment is preferably followed by thickness restoring treatment. The thickness restoring treatment is a step in which the receiving sheet is contacted with a metal heating roll with the pressure released, and heated. When the receiving sheet is subjected to smoothing treatment through a pressurized nip section formed between a pair of rolls consisting of a metal heating roll and an elastic roll, the surface smoothness is improved but the interior of the receiving sheet, especially the interlayer, becomes compressed and causes a reduction in thickness. After the receiving sheet has passed through the nip section and is immediately contacted with the heating roll with the pressure released, the interlayer expands to a degree that increases the thickness, and therefore the density of the entire interlayer decreases, thus allowing increased image quality and printing density of the receiving sheet. The temperature of the heating roll in the thickness restoring treatment step may be the same as the heating roll in the preceding smoothing treatment, and it is preferably 30-130° C. The contact time between the receiving sheet and metal heating roll is preferably at least 0.5 second and more preferably 1 second or longer.

According to the invention, the smoothing treatment conditions for smoothing of the coated surface of the receiving layer will be significantly affected by the thermal properties of the dye-dyeable resin in the receiving layer (particularly the glass transition temperature of the resin). If the resin has a high glass transition temperature, the resin will be resistant to heat deformation and not easily smoothed. By adjusting the surface layer temperature of the receiving sheet to the prescribed range before the smoothing step as according to this invention, it is possible to promote plasticization of the resin in a short period of time and efficiently accomplish smoothing treatment.

The smoothness of the receiving sheet, i.e. the ratio of contact between the receiving sheet and the thermal head, is important in terms of the printing density and print quality of the receiving sheet, and as regards the smoothness of the receiving layer surface, it was found that high sensitivity and high quality images can be obtained by adjusting the printing smoothness (Rp value) of the receiving layer surface to 0-4.0 μm, as measured using a microtopograph with an applied pressure of 0.05 MPa. An Rp value of greater than 4.0 μm may produce a receiving sheet surface with insufficient smoothness, possibly leading to inferior printing density and print quality of the receiving sheet. The Rp value is more preferably 0-3.0 μm. The printing smoothness (Rp value) was determined by measuring the physical quantity proportional to the average depth of depressions on a test material surface contact bonded onto a standard flat surface (prism), using the principle of measurement described in Japan Federation of Printing Industries Collection, Vol. 17, No. 3 (1978) and in 60th Spring Conference of the Japan Federation of Printing Industries (1978).

### EXAMPLES

The invention will now be explained in greater detail using examples, with the understanding that the invention is in no way limited in scope by the examples.

Unless otherwise specified, the “parts” and “%” values in the examples all refer to parts by mass and mass percentages, respectively, and are solid contents minus any solvents.

### Production of Polyester Resins

The polyhydric carboxylic acid components and polyhydric alcohol components shown in Table 1 below were used to synthesize different polyester resins by known processes.

TABLE 1
(Polyester resin)

| | | | | | | | | | Resin properties | |
|---|---|---|---|---|---|---|---|---|---|---|
| | | | | | | | | | | Number- |
| | | | | | | | | | Glass | average |
| | Carboxylic acid component | | | | Alcohol component | | | | transition | molecular |
| Polyester | Isophthalic | Succinic | Cyclohexane | Trimellitic | Bisphenol | Cyclohexane | Ethylene | Trimethylol- | temperature | weight |
| resins | acid | anhydride | dicarboxylic acid | acid | A/EO adduct | dimethanol | glycol | propane | (° C.) | (MW) |
| A | 60 | 0 | 40 | 0 | 60 | 0 | 35 | 5 | 62 | 12,000 |
| B | 45 | 30 | 25 | 0 | 25 | 0 | 70 | 5 | 50 | 10,000 |
| C | 45 | 25 | 25 | 5 | 75 | 0 | 25 | 0 | 67 | 12,000 |
| D | 55 | 0 | 45 | 0 | 40 | 40 | 15 | 5 | 63 | 11,000 |
| E | 55 | 0 | 45 | 0 | 0 | 25 | 70 | 5 | 53 | 12,000 |
| F | 20 | 80 | 0 | 0 | 0 | 0 | 100 | 0 | 72 | 22,000 |
| G | 0 | 0 | 100 | 0 | 0 | 0 | 100 | 0 | 98 | 18,000 |
| H | 100 | 0 | 0 | 0 | 0 | 0 | 100 | 0 | 82 | 18,000 |

### Example 1

### Formation of Interlayer

Using 150 μm-thick art paper (174.4 g/m², trade name: OK Kinfuji N, Oji Paper Co., Ltd.) as a sheet-like support, an interlayer coating solution 1 having the composition listed below was applied onto one side thereof to a post-drying thickness of 51 μm, and was dried to form an interlayer.

### Interlayer Coating Solution 1

| | |
|---|---|
| Prefoamed hollow particles made of a copolymer composed | 50 parts |
| mainly of acrylonitrile and methacrylonitrile (mean | |
| particle size: 3.2 μm, volume hollowness: 76%) | |
| Polyvinyl alcohol (trade name: PVA205, Kuraray Co., Ltd.) | 10 parts |
| Styrene-butadiene latex (trade name: PT1004, Zeon Corp.) | 40 parts |
| Water | 250 parts |

### Formation of Barrier Layer and Receiving Layer

A barrier layer coating solution 1 having the composition listed below was further coated on the interlayer to a solid coating coverage of 2 g/m² and dried to form a barrier layer, after which a receiving layer coating solution 1 having the composition listed below was coated onto the barrier layer to a solid coating coverage of 5 g/m² and dried to form a receiving layer. Barrier layer coating solution 1

| | |
|---|---|
| Expansive inorganic laminar compound (sodium tetrasilicic | 30 parts |
| mica, mean particle length: 6.3 μm, aspect ratio: 2700) | |
| Polyvinyl alcohol (trade name: PVA105, Kuraray Co., Ltd.) | 50 parts |
| Styrene-butadiene latex (trade name: L-1537, Asahi Kasei | 20 parts |
| Corp.) | |
| Water | 1100 parts |

### Receiving Layer Coating Solution 1

| | |
|---|---|
| Polyester resin A | 100 parts |
| Epoxy polyether-modified silicone oil (trade name: | 10 parts |
| SF8421, Dow Corning Toray Silicone) | |
| Alcohol-modified silicone oil (trade name: SF8427, Dow | 2 parts |
| Corning Toray Silicone) | |
| Isocyanate compound (trade name: NY-710A, Mitsubishi | 5 parts |
| Chemical Corp.) | |
| Toluene | 100 parts |
| Methyl ethyl ketone | 100 parts |

### Formation of Back Surface Layer

The back surface layer coating solution 1 having the composition listed below was coated onto the surface of the sheet-like support opposite the side on which the receiving layer was formed, to a post-drying solid coating coverage of 3 g/m², and then dried to form a back surface layer and heat treated at 50° C. for 4 days. For further surface smoothing of the receiving sheet, calender treatment (roll surface temperature: 78° C., nip pressure: 2.5 MPa) is performed to complete the receiving sheet.

### Back Surface Layer Coating Solution 1

| | |
|---|---|
| Polyvinylacetal resin (trade name: S-LEC KX-1, Sekisui | 40 parts |
| Chemical Industries, Ltd.) | |
| Polyacrylic acid ester resin (trade name: JURIMER AT613, | 20 parts |
| Nihon Junyaku Co., Ltd.) | |
| Nylon resin particles (trade name: MW330, Shinto Paint | 10 parts |
| Co., Ltd.) | |
| Zinc stearate (trade name: Z-7-30, Chukyo Yushi Co., | 10 parts |
| Ltd.) | |
| Cationic conductive resin (trade name: CHEMISTAT 9800, | 20 parts |
| Sanyo Chemical Industries, Ltd.) | |
| Water/isopropyl alcohol = ⅔ (mass ratio) mixture | 400 parts |

### Example 2

A receiving sheet was prepared in the same manner as Example 1, except that receiving layer coating solution 2 was used instead of the receiving layer coating solution 1.

### Receiving Layer Coating Solution 2

| | |
|---|---|
| Polyester resin A | 100 parts |
| Epoxy-modified silicone oil (trade name: KF105, Shin-Etsu | 10 parts |
| Chemical Co., Ltd.) | |
| Alcohol-modified silicone oil (trade name: SF8427, Dow | 2 parts |
| Corning Toray Silicone) | |
| Isocyanate compound (trade name: NY-710A, Mitsubishi | 5 parts |
| Chemical Corp.) | |
| Toluene | 100 parts |
| Methyl ethyl ketone | 100 parts |

### Example 3

A receiving sheet was prepared in the same manner as Example 1, except that as the sheet-like support in Example 1 there was used a laminated sheet-like support prepared by the method described below instead of 150 μm-thick art paper (trade name: OK Kinfuji N, 174.4 g/m², Oji Paper Co., Ltd.), and coating of the interlayer and barrier layer was not performed.

### (Preparation of Laminated Sheet-Like Support)

A biaxial stretched film with a porous multilayer structure and composed mainly of polypropylene (trade name: YUPO FPG50, Yupo Corporation) was laminated onto both sides of 100 μm-thick woodfree paper using a dry laminating system to obtain a sheet-like support.

### Example 4

A receiving sheet was prepared in the same manner as Example 1, except that polyester resin B was used instead of polyester resin A in the receiving layer coating solution 1 of Example 1.

### Example 5

A receiving sheet was prepared in the same manner as Example 1, except that polyester resin C was used instead of polyester resin A in the receiving layer coating solution 1 of Example 1.

### Example 6

A receiving sheet was prepared in the same manner as Example 1, except that polyester resin D was used instead of polyester resin A in the receiving layer coating solution 1 of Example 1.

### Example 7

A receiving sheet was prepared in the same manner as Example 1, except that polyester resin E was used instead of polyester resin A in the receiving layer coating solution 1 of Example 1.

### Example 8

A receiving sheet was prepared in the same manner as Example 1, except that receiving layer coating solution 3 having the composition listed below was used instead of the receiving layer coating solution 1.

### Receiving Layer Coating Solution 3

| | | |
|---|---|---|
| Polyester resin A | 100 | parts |
| Reactive polyether-modified silicone oil (trade name: | 7 | parts |
| X22-4272, Shin-Etsu Chemical Co., Ltd.) | | |
| Non-reactive polyether-modified silicone oil (trade name: | 1 | part |
| SH8400, Dow Corning Toray Silicone) | | |
| Isocyanate compound (trade name: NY-710A, Mitsubishi | 9 | parts |
| Chemical Corp.) | | |
| Toluene | 100 | parts |
| Methyl ethyl ketone | 100 | parts |

### Example 9

A receiving sheet was prepared in the same manner as Example 1, except that receiving layer coating solution 4 having the composition listed below was used instead of the receiving layer coating solution 1.

### Receiving Layer Coating Solution 4

| | |
|---|---|
| Polyester resin A | 80 parts |
| Bisphenol Z-polycarbonate resin (trade name: TS-2020, | 20 parts |
| Teijin Chemicals, Ltd.) | |
| Epoxy polyether-modified silicone oil (trade name: | 10 parts |
| SF8421, Dow Corning Toray Silicone) | |
| Alcohol-modified silicone oil (trade name: SF8427, Dow | 2 parts |
| Corning Toray Silicone) | |
| Isocyanate compound (trade name: NY-710A, Mitsubishi | 5 parts |
| Chemical Corp.) | |
| Toluene | 100 parts |
| Methyl ethyl ketone | 100 parts |

### Example 10

### Formation of Back Surface Layer

Using 150 μm-thick art paper (174.4 g/m², trade name: OK Kinfuji N, Oji Paper Co., Ltd.) as a sheet-like support, a back surface layer coating solution 1 (prepared in Example 1) was applied onto one side thereof to a post-drying solid coating coverage of 3 g/m², and was dried to form a back surface layer.

### Formation of Interlayer

Next, interlayer coating solution 2 having the composition listed below was coated onto the side of the sheet-like support opposite the side on which the back surface layer was formed, to a post-drying thickness of 43 μm, and then dried to form an interlayer.

### Interlayer Coating Solution 2

| | |
|---|---|
| Polyvinylidene chloride-based foamed hollow particles | 35 parts |
| (volume hollowness: 93%, mean particle size: 4 μm) | |
| Polyvinyl alcohol (trade name: PVA205, Kuraray Co., Ltd.) | 15 parts |
| Styrene-butadiene latex (trade name: PT1004, Zeon Corp.) | 50 parts |
| Water | 200 parts |

### Preparation of Receiving Sheet

A barrier layer coating solution 2 having the composition listed below was further coated on the interlayer to a solid coating coverage of 2 g/m² and dried to form a barrier layer, after which a receiving layer coating solution 5 having the composition listed below was coated onto the barrier layer to a solid coating coverage of 5 g/m² and dried to form a receiving layer, which was then cured at 50° C. for 48 hours. A calender apparatus comprising a preheating apparatus, a metal heating roll and elastic roll and a thickness restoring roll was used for smoothing treatment under conditions with a pre-nipping receiving sheet temperature of 50° C., a metal heating roll temperature of 70° C., a nipping time of 50 msec, a nip pressure of 10 MPa, a thickness restoring roll temperature of 70° C. and a thickness restoring time of 2 seconds to prepare a receiving sheet with a receiving layer surface Rp value of 1.0 μm.

### Barrier Layer Coating Solution 2

| | |
|---|---|
| Polyvinyl alcohol (trade name: PVA117, Kuraray Co., Ltd.) | 100 parts |
| Water | 1000 parts |

### Receiving Layer Coating Solution 5

| | |
|---|---|
| Polyester resin A | 100 parts |
| Silanol group-containing methylphenylpolysiloxane (trade | 10 parts |
| name: TSR160, GE-Toshiba Silicone, hydroxyl content: | |
| approximately 4.5 wt %) | |
| Polyether-modified silicone oil (trade name: SF8428, Dow | 3 parts |
| Corning Toray Silicone) | |
| Isocyanate compound (trade name: NY-710A, Mitsubishi | 12 parts |
| Chemical Corp.) | |
| Toluene | 100 parts |
| Methyl ethyl ketone | 100 parts |

### Example 11

A receiving sheet was prepared in the same manner as Example 10, except that receiving layer coating solution 6 having the composition listed below was used instead of the receiving layer coating solution 5.

### Receiving Layer Coating Solution 6

| | |
|---|---|
| Polyester resin B | 100 parts |
| Silanol group-containing methylphenylpolysiloxane (trade | 20 parts |
| name: 220FLAKE, Dow Corning Toray Silicone, hydroxyl | |
| content: approximately 6 wt %) | |
| Polyether-modified silicone oil (trade name: SF8428, Dow | 3 parts |
| Corning Toray Silicone) | |
| Isocyanate compound (trade name: NY-710A, Mitsubishi | 12 parts |
| Chemical Corp.) | |
| Toluene | 100 parts |
| Methyl ethyl ketone | 100 parts |

### Comparative Example 1

A receiving sheet was prepared in the same manner as Example 1, except that polyester resin F was used instead of polyester resin A in the receiving layer coating solution 1 of Example 1.

### Comparative Example 2

A receiving sheet was prepared in the same manner as Example 1, except that polyester resin G was used instead of polyester resin A in the receiving layer coating solution 1 of Example 1.

### Comparative Example 3

A receiving sheet was prepared in the same manner as Example 1, except that polyester resin H was used instead of polyester resin A in the receiving layer coating solution 1 of Example 1.

### Comparative Example 4

A receiving sheet was prepared in the same manner as Example 1, except that cellulose butyrate acetate (trade name: CAB551-0.01, Eastman Chemical Company) was used instead of polyester resin A in the receiving layer coating solution 1 of Example 1.

### Evaluation

The receiving sheets obtained in the examples and comparative examples described above were subjected to the following tests. The results are shown in Table 2.

### [Printing Density Test]

For the obtained receiving sheet there was used a commercially available thermal transfer video printer (trade name: UP-50, Sony Corporation) equipped with a sublimating dye transfer ribbon (trade name: UP-540, Sony Corporation), a black solid image was printed in a 20° C. environment, and then a reflecting densitometer (trade name: Macbeth RD-914, Gretag Macbeth) was used to measure the printing density. The printing density was measured at 5 points, with an average density of 2.1 or greater being considered a practical level.

### [Light Fastness Test]

The aforementioned print was treated with a Xe fadeometer to a cumulative lux of 10,000 kJ/m², and the color difference of the print before and after treatment was determined.

The color difference was determined using a color difference meter (Gretag Macbeth) according to the method specified by JIS Z 8722 for measurement of the reflectance properties before and after treatment of the print, and calculating the color difference ΔE* before and after treatment of the print, according to the method specified by JIS Z 8730. A color difference of within 13 is a practical level for use.

### [Protective Layer Transfer Property Test]

A thermal transfer tester (trade name: TH-PMI2, Okura Electric Co.) was used to transfer the protective layer portion of a sublimating dye transfer ribbon (trade name: UP-540, Sony Corporation) onto the receiving layer of the obtained receiving sheet while varying the applied energy, and the minimum energy which allowed transfer of the protective layer was recorded. A minimum energy of no greater than 1 mj/dot for the protective layer transfer in the protective layer transfer property test was considered a practical level of transfer property.

### [Ribbon Releasability Test]

A commercially available thermal transfer video printer (trade name: UP-50, Sony Corporation) equipped with a sublimating dye transfer ribbon (trade name: UP-540, Sony Corporation) was used for consecutive printing of a black solid image on 10 of the obtained receiving sheets in a 50° C. environment. During this time, the condition of fusion between the receiving sheet and ribbon and the ejectability of the receiving sheet from the printer were evaluated on the following scale, as a measure of suitability for printing.

Good: Absolutely no fusion between receiving sheet and ribbon, all 10 consecutive sheets ejected properly, and no problems encountered in actual use.

Fair: Slight noise produced due to some fusion between receiving sheet and ribbon, but all 10 sheets were ejected and suitable for actual use.

Failure: Fusion between receiving sheet and ribbon, some sheets not ejected properly and unsuitable for actual use.

TABLE 2

| | Receiving | Basic | | Light | Protective | |
|---|---|---|---|---|---|---|
| | layer | structure | | fastness | layer | |
| | resin | of | | [color | transfer | |
| | (main | receiving | Printing | difference: | property | Ribbon |
| | component) | layer resin | density | ΔE*] | (mJ) | releasability |
| Example 1 | Polyester A | branched | 2.52 | 3 | 0.2 | good |
| Example 2 | Polyester A | branched | 2.57 | 5 | 0.3 | good |
| Example 3 | Polyester A | branched | 2.58 | 4 | 0.1 | good |
| Example 4 | Polyester B | branched | 2.51 | 6 | 0.4 | good |
| Example 5 | Polyester C | branched | 2.54 | 7 | 0.5 | good |
| Example 6 | Polyester D | branched | 2.53 | 8 | 0.4 | good |
| Example 7 | Polyester E | branched | 2.54 | 5 | 0.5 | good |
| Example 8 | Polyester A | branched | 2.55 | 4 | 0.3 | good |
| Example 9 | Polyester A | branched | 2.52 | 2 | 0.2 | good |
| Example 10 | Polyester A | branched | 2.53 | 4 | 0.3 | good |
| Example 11 | Polyester B | branched | 2.51 | 7 | 0.4 | good |
| Comparative | Polyester F | straight- | 1.78 | 20 | 0.7 | failure |
| Example 1 | | chain | | | | |
| Comparative | Polyester G | straight- | 1.58 | 8 | 0.8 | failure |
| Example 2 | | chain | | | | |
| Comparative | Polyester H | straight- | 2.48 | 25 | 1.6 | failure |
| Example 3 | | chain | | | | |
| Comparative | CAB551- | cellulose | 1.33 | 20 | 0.8 | failure |
| Example 4 | 0.01 | acetate | | | | |
| | | butyrate | | | | |

### INDUSTRIAL APPLICABILITY

The receiving sheet of the invention has high printing density, satisfactory light fastness of images, and excellent ink ribbon protective layer transferability and releasability between the receiving layer and ink ribbon, even during high-speed printing, and it is useful for full color printers with different types of thermal transfer systems, including sublimation heat transfer systems, and can therefore provide a major contribution to the industry.

1: A thermal transfer receiving sheet comprising a sheet-like support and an image receiving layer formed on at least one side of the sheet-like support, the thermal transfer receiving sheet being characterized in that the image receiving layer contains a polyester resin with a branched structure obtained by polycondensation of a polyhydric carboxylic acid component and a polyhydric alcohol component, and in that 30-75 mol % of the polyhydric carboxylic acid component is an aromatic dicarboxylic acid while 15-60 mol % is an alicyclic dicarboxylic acid.

2: The thermal transfer receiving sheet according to claim 1, wherein the polycondensation components of the polyester include 0.5-10 mol % of a trihydric or greater alcohol component and/or a trihydric or greater carboxylic acid component as the polyhydric alcohol component or polyhydric carboxylic acid component, respectively.

3: The thermal transfer receiving sheet according to claim 1, wherein 10-80 mol % of the polyhydric alcohol component is an alicyclic glycol compound and/or aromatic glycol compound.

4: The thermal transfer receiving sheet according to any one of claims 1 to 3, wherein the image receiving layer contains a reaction product comprising the polyester resin and an epoxy-modified silicone and/or epoxy polyether-modified silicone as components.

5: The thermal transfer receiving sheet according to claim 4, wherein another component of the reaction product is an alcohol-modified silicone.

6: The thermal transfer receiving sheet according to any one of claims 1 to 3, wherein the image receiving layer contains a reaction product comprising (a) the polyester resin, (b) an isocyanate compound and (c) an isocyanate group-reactive polyether-modified silicone and/or carbinol-modified silicone, and further includes a non-reactive polyether-modified silicone.

7: The thermal transfer receiving sheet according to any one of claims 1 to 3, wherein the image receiving layer contains a bisphenol A-polycarbonate resin and/or bisphenol Z-polycarbonate resin.

8: The thermal transfer receiving sheet according to any one of claims 1 to 3, wherein the image receiving layer contains a silanol group-containing polysiloxane at 1-40 parts by weight with respect to 100 parts by mass of the dye-dyeable resin.

9: The thermal transfer receiving sheet according to claim 8, wherein the silanol group-containing polysiloxane is a silanol group-containing methylphenylpolysiloxane.

10: The thermal transfer receiving sheet according to claim 2, wherein 10-80 mol % of the polyhydric alcohol component is an alicyclic glycol compound and/or aromatic glycol compound.
